(19) United States
(12) Patent Application Publication
(10) Pub. No.: US 2005/0116971 A1
(43) Pub. Date: Jun. 2, 2005

(54) PRINTER AND RELATED APPARATUS FOR ADJUSTING INK-JET ENERGY ACCORDING TO PRINT-HEAD TEMPERATURE

(76) Inventor: Sheng-Lung Tsai, Ping-Tung Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,761

(22) Filed: Nov. 26, 2004

(30) Foreign Application Priority Data
Nov. 27, 2003 (TW) 092133303

(51) Int. Cl. B41J 29/38

(52) U.S. Cl. 347/9

(57) ABSTRACT

An ink-jet printer includes a negative thermal coefficient thermistor for sensing temperature of the print head, and a monostable multivibrator, connected to the thermistor and a capacitor for realizing a pulse duration control circuit, such that the pulse duration control circuit generates a print enable signal with a duration corresponding to resistance of the thermistor. When the printer starts to jet ink, it supplies energy according to the duration of the print enable signal to heat ink, so that if temperature of the print head rises, the duration of the print enable signal decreases and energy supplied to heat ink will become less accordingly, thus degradation of printing due to heat accumulation is avoided.

### BACKGROUND OF INVENTION

1. Field of the Invention

The present invention provides an ink-jet printer and related apparatus capable of adjusting ink-jet energy according to print-head temperature instantly, and more particularly, a printer and related apparatus for controlling temperature adjustment by a simple circuit structure having a monostable multivibrator with a thermistor.

2. Description of the Prior Art

In modern information society, ink-jet printers are one of the most popular types of printers because of low price and outstanding print quality. Information technology companies are eager to develop more progressive ink-jet print techniques to decrease cost and increase quality.

In general, an ink-jet printer heats ink in nozzles of a print head while printing. The print head connected to an ink cartridge includes a plurality of nozzles, and near each nozzle is a corresponding heating unit (such as a transistor including a heating resistor), which heats nearby ink. When jetting ink, the ink-jet printer transmits heating energy to each heating unit, and then jets an ink drop from a corresponding nozzle to a print document (such as paper or other medium). According to print data, such as words and pictures, the print head controls different nozzles to jet or not to jet ink to the print document repeatedly.

However, in the above ink-jet process, because the heating unit of each nozzle is heated repeatedly, ink temperature in the print head increases resulting in a heat accumulation phenomenon. In comparison with a heat dissipation situation (for example, as occurs when starting to print), if the printer triggers the heating unit with the same energy and causes heat accumulation (for example, the printer has printed for a long time), owing to both decreased viscosity of hot ink and continuous heating of the heating unit, the nozzles jet too much ink so larger ink drops are printed to the print document. The larger the ink drops, the lower the print resolution (like dots per inch, DPI), print clarity, and quality of ink-jet printing. In order to prevent this negative effect of heat accumulation, several ink-jet printing techniques have been developed.

Those skilled in the art will recognize that techniques for compensating for heat accumulation can be divided into two types, one type is an open-loop trigger control mode, and the other type is a closed-loop trigger control mode. As disclosed in U.S. Pat. Nos. 5,036,337 and 5,790,144, in the open-loop trigger control mode, an ink-jet printer predicts heat accumulation in a print head according to print data. For example, if the print data have repeatedly triggered a lot of heating units to heat ink in a short time, the ink-jet printer can predict that its print head will encounter more heat accumulation, so that each heating unit is provided with less energy to avoid the ink drops becoming too large. However, what cause print head heat accumulation are not only the print data, but also other factors (such as remaining ink in the print head and the ink cartridge). Therefore, heat accumulation cannot be predicted exactly by the print data; that is, the open-loop trigger control mode cannot prevent heat accumulation completely.

In addition, the U.S. Pat. No. 6,394,572 discloses a close-loop trigger control mode. In the close-loop trigger control mode, the ink-jet printer controls ink-jet trigger energy by measuring temperature of the print head through a thermistor. Please refer to FIG. 1 illustrating a block diagram of the prior art close-loop trigger control mode in a printer 10. The printer 10 is an ink-jet printer that includes an interface circuit 12, a system control circuit 14, a non-volatile memory device 15, a drive circuit 16, a print head 18, a measure circuit 20, and an A/D (analog to digital) converter 22. The interface circuit 12 receives waiting print data from a data source 24 (or a host such as a PC). The system control circuit 14 controls operations of the printer 10. The memory 25 registers data for operations of the system control circuit 14 by a non-volatile method. The print head 18 includes K nozzles Np(1), Np(2) . . . Np(K), and heating units Qp(1), Qp(2) . . . Qp(K) each corresponding to the nozzles. The drive circuit 16 triggers drive signals Sp(1), Sp(2) . . . Sp(K) to the heating units Qp(1), Qp(2) . . . Qp(K) under control of the system control circuit 14. After receiving the corresponding drive signals, each heating unit heats nearby ink corresponding to the nozzles and then jets the ink to a print document 29.

In order to compensate for heat accumulation in the close-loop trigger control mode, the print head 18 of the printer 10 further includes a thermistor TRp, whose resistance changes as the temperature of the print head 18 changes. In general, heating units and corresponding nozzles are deposited in an ink-jet chip so uniformly that the thermistor TRp layouts surrounding each nozzle (such as the oblique line blocks in FIG. 1) measure temperature of the whole chip. The measure circuit 20 includes two connection ends cp1 and cp2 each connected to one end of the circular thermistor, which is equivalent to connecting the connection ends cp1 and cp2 through the thermistor TRp. Functions of the measure circuit 20 are measuring resistance of the thermistor TRp, and generating a corresponding outcome 28A. For example, the measure circuit 20 transmits a stable current to the thermistor TRp to measure the cross voltage of the thermistor TRp; the cross voltage represents the resistance of the thermistor TRp as the outcome 28A. Because the system control circuit 14 calculates trigger energy according to the resistance of the thermistor TRp in the close-loop trigger control mode, the prior art printer 10 therefore includes an A/D converter 22 to transfer the analog outcome 28A of the measure circuit 20 to the digital outcome 28B, and to feedback the outcome 28B to the system control circuit 14. Following that, the system control circuit 14 estimates energy of drive signals for each heating unit based on the outcome 28B. In general, the system control circuit 14 estimates the energy according to a look-up table, and the prior art printer 10 therefore requires space in the memory device 15 for this table.

As to heat accumulation compensation of the prior art printer 10 in the close-loop trigger control mode, please refer to FIG. 2 (and FIG. 1), which illustrates a related signal waveform time domain diagram whose X-axis is time scale and Y-axis is waveform amplitude. When printing, the printer 10 receives waiting print data provided by the data source 24 through the interface circuit 12, and then registers the data into the memory 25. If the printer 10 starts jetting ink at time point tp1, according to the table stored in the memory device 15, the system control circuit 14 will estimate trigger energy corresponding to the outcome 28B provided by the measure circuit 20 and the A/D converter 22. After that, a print enable signal 26B drops from level H to level L at time point tp1, and the system control circuit 14 controls the level L maintenance time. Besides, the print enable signal 26B will be transmitted to the drive circuit 16. Meanwhile, the waiting print data registered in the memory 25 is transmitted to the drive circuit 16 as the print data 26A shown in FIG. 1.

After receiving the print data 26A, the drive circuit 16 determines which nozzles need to jet ink and which do not. The drive circuit 16 provides an ink-jet drive signal for corresponding ink-jet units. If the print head 18 (in FIG. 1) has a nozzle Np(k) required to jet, the drive circuit 16 will trigger the heating unit Qp(k) to heat ink with a corresponding drive signal Sp(k) as shown in FIG. 2. The waveform in FIG. 2 shows that the drive circuit 16 generates the same pulse wave width of a drive signal Sp(k) as the pulse wave width Tp1 of the print enable signal 26B; that is, when the print enable signal 26B drops from the level H to the level L at time point tp1, the drive signal Sp(k) rises from the level Dl to the level Dh. Between time points tp1 and tp2, the print enable signal maintains the level L, so that the drive signal Sp(k) maintains the level Dh, whose corresponding heating unit Qp(k) heats ink continuously to jet ink through corresponding nozzle Np(k). At time point tp2, since the system control circuit 14 pulls the print enable signal 26B to the level H, the drive circuit 16 pushes the drive signal Sp(k) to the level Dl accordingly. Therefore, the heating unit Qp(k) stops heating ink.

In other words, the level L of the print enable signal 26B can be seen as an enable level. When the print enable signal 26B maintains the enable level (during time slot Tp1), the drive signal Sp(k) triggers the heating unit Qp(k) to heat ink with the level Dh signal (which can be seen as a drive level). The longer the print enable signal 26B in the enable level, the longer the heating unit Qp(k) is active, and the more heating energy is imparted to the ink. The system control circuit 14 controls the enable level L duration (the pulse wave width of the print enable signal) based on the outcome 28B, so as to control ink-heating energy amount for the heating units. Continuing with FIG. 2, if the printer 10 triggers the nozzle Np(k) again at time point tp3, the system control circuit 14 transfers the print enable signal 26B from the level H to the enable level L at time point tp3, and the drive circuit 16 transfers the drive signal Sp(k) from the level Dl to the drive level Dh. In this case, if the print head 18 between time points tp1 and tp2 has undergoes too much heat accumulation, the resistance of the thermistor TRp will be changed. When the print enable signal 26B drops to the enable level L at time point tp3, the system control circuit 14 re-estimates the enable maintenance time of the print enable signal 26B according to the outcome 28B provided by the measure circuit 20 and the A/D converter 22. Moreover, owing to heat accumulation, the system control circuit 14 maintains the print enable signal 26B at the enable level for a shorter time slot Tp2 (compared to the time slot Tp1), so that the drive circuit 16 also maintains the drive signal Sp(k) at the enable level Dh for a shorter time slot. Therefore, the heating unit Qp(k) heats ink with less energy, so as to compensate for the heat accumulation effect.

One of the drawbacks of the above prior art technique is necessary calculation resources of a printer. As mentioned above, the prior art printer 10 needs the A/D converter 22 to transfer the analog outcome 28A of the thermistor TRp to the digital outcome 28B for heat accumulation compensation. Furthermore, the prior art technique occupies both calculation and memory resources (the table stored in the memory device 15) of the printer 10, so as to calculate the enable level maintenance duration of the print enable signal 26A. Consequently, use of these system resources degrades efficiency of the printer.

### SUMMARY OF INVENTION

It is therefore a primary objective of the claimed invention to provide a printer and related apparatus that can adjust ink-jet energy according to print-head temperature in order to compensate for heat accumulation.

According to the claimed invention, a printer includes: a print head including at least one nozzle, each nozzle for heating ink for jetting ink to a print document; a thermistor disposed in the print head, wherein resistance of the thermistor changes as temperature of the print head changes; a pulse duration control circuit providing a current for a capacitor through the thermistor, generating a print enable signal based on a discharging and charging duration for the current flowing to the capacitor, enabling an enable maintenance duration of the print enable signal corresponding to the discharging and charging duration for the current flowing to the capacitor; and a drive circuit, connected between the pulse duration control circuit and the print head, generating at least one ink-jet drive signal based on the print enable signal, enabling energy of each ink-jet drive signal corresponding to the enable maintenance duration of the print enable signal; each jet ink drive signal corresponding to a nozzle for heating ink with the corresponding nozzle according to the corresponding energy of the jet ink drive signal.

According to the claimed invention, a method for a printer to adjust energy of each nozzle in the print head for heating ink according to the print head's temperature, the method includes: providing a thermistor in the print head, the resistance of the thermistor changing as temperature of the print headchanges; processing a wave control step for providing a current for a capacitor through the thermistor, generating a print enable signal based on a discharging and charging duration for the current flowing to the capacitor, enabling an enable maintenance duration of the print enable signal corresponding to the discharging and charging duration for the current flowing to the capacitor; and processing a drive step for generating at least one ink-jet drive signal according to the print enable signal, enabling the energy of each ink-jet drive signal corresponding to the enable maintenance duration of the print enable signal; each ink-jet drive signal corresponding to a nozzle for heating ink by the corresponding nozzle based on the corresponding energy of the jet ink drive signal.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a block diagram of a prior art ink-jet printer when compensating for heat accumulation.

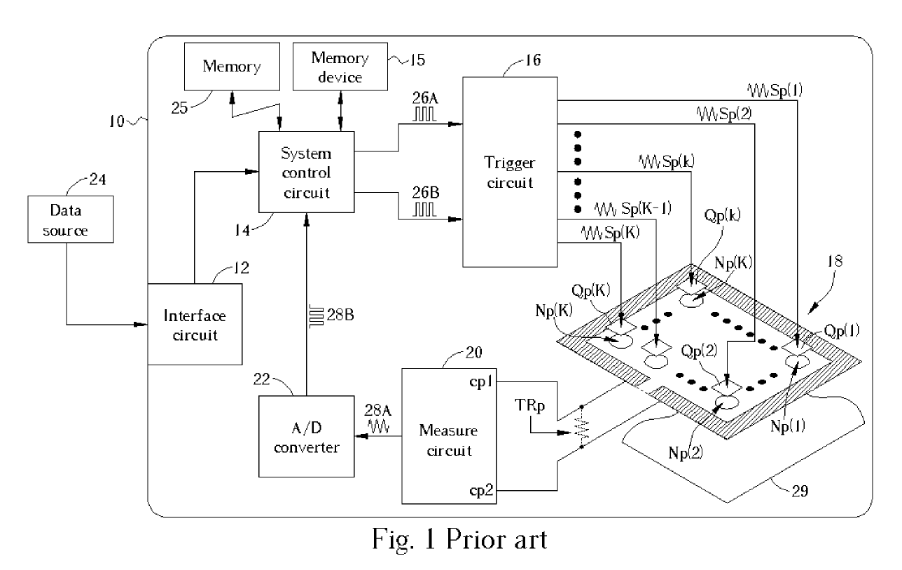

FIG. 2 illustrates a schematic diagram of each related signal waveform in the time domain when the printer in FIG. 1 is operating.

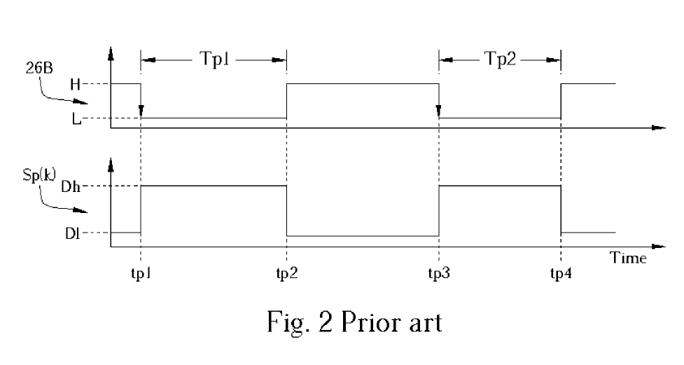

FIG. 3 illustrates a block diagram of a typical monostable multivibrator.

FIG. 4 illustrates a schematic diagram of each related signal waveform in the time domain when the monostable multivibrator in FIG. 3 operates.

FIG. 5 illustrates a block diagram of the present invention printer.

FIG. 6 illustrates a schematic diagram of each related signal waveform in the time domain when the printer in FIG. 5 operates.

FIG. 7 illustrates a functional diagram of temperature versus pulse wave width when the printer in FIG. 5 compensates for heat accumulation.

FIG. 8 illustrates a schematic diagram of the monostable multivibrator in FIG. 3.

FIG. 9 illustrates a schematic diagram of each related signal waveform in the time domain when the circuit in FIG. 8 is operating.

### DETAILED DESCRIPTION

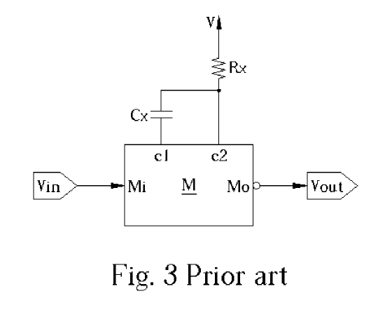

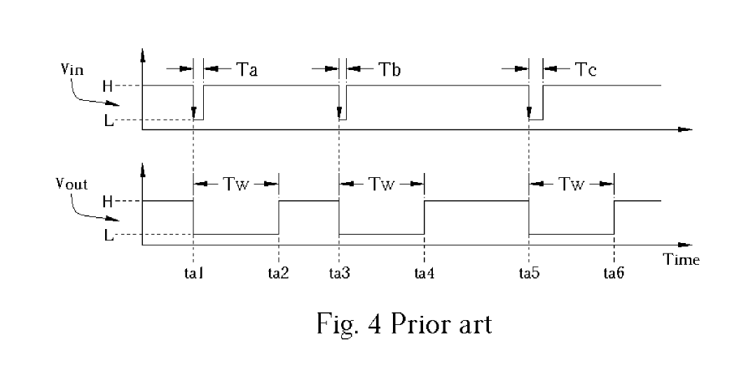

In the implementation of the present invention, a monostable multivibrator of the present invention directly adjusts pulse wave width of a print enable signal according to resistance of a thermistor. Please refer to FIG. 3 and FIG. 4. FIG. 3 illustrates a configuration diagram of a typical monostable multivibrator M, while FIG. 4 illustrates a related signal waveform time domain diagram of the monostable multivibrator M in FIG. 3. The X-axis in FIG. 4 is time scale, and Y-axis is waveform amplitude. The typical monostable multivibrator M includes an input end Mi, an output end Mo, and two connection ends c1 and c2. The input end Mi receives an input signal Vin (such as an input voltage signal); the output end Mo outputs an output signal Vout. The connection ends c1 and c2 connect to a capacitor Cx and a resistor Rx respectively as shown in FIG. 3, where the voltage V is a stable bias voltage.

As FIG. 4 illustrates, the monostable multivibrator M is triggered at the falling edge of the input signal Vin (when the level H changes to the level L). After being triggered, the monostable multivibrator M forms a pulse wave in the output signal, the pulse wave width being directly proportional to the product of the capacitance of the capacitor Cx and the resistance of the resister Rx. For example, as FIG. 4 illustrates, if the input signal Vin triggers the monostable multivibrator M to operate at time point ta1, the monostable multivibrator M will transfer the output signal Vout from the level H to the level L at time point ta1, and maintain the output signal Vout at the level L between time points ta1 and ta2. The generated level L pulse wave with a pulse wave width Tw is directly proportional to the product of the capacitance of the capacitor Cx and the resistance of the resistor Rx. At time point ta2, the monostable multivibrator M returns the output signal Vout from the level L to the level H automatically.

According to the same method, after the input signal Vin triggers the monostable multivibrator M at the falling edge at time point ta3, the monostable multivibrator M generates the level L pulse wave with the pulse wave width Tw in the output signal Vout; that is, after a duration of the pulse wave width Tw from the time point ta3, the monostable multivibrator M returns the output signal Vout to the level H. Similarly, the input signal Vin triggers the monostable multivibrator M at time point ta5, and returns to the level H at time point ta6 after a duration of the pulse wave width Tw. Basically, pulse wave widths of the input signal Vin at time points ta3, ta5, and ta7 can be different or very short, such as Ta, Tb, and Tc (in comparison with the pulse wave width Tw), but after being triggered, the monostable multivibrator M can automatically output the level L pulse wave of width Tw according to the product of the capacitance of the capacitor Cx and the resistance of the resistor Rx. In addition, those skilled in the art recognize that the monostable multivibrator M can be implemented in many different ways, however a typical monostable multivibrator changes output signal levels under input signal triggers (such as from the level H to the level L, shown in FIG. 4), and discharges and charges the capacitor Cx through the resistor Rx at the same time. Being discharged and charged, the capacitor Cx triggers the monostable multivibrator level to return (such as from the level L to the level H), so as to output a pulse wave with a pulse wave width proportional to the product of the capacitance of the capacitor Cx and the resistance of the resistor Rx.

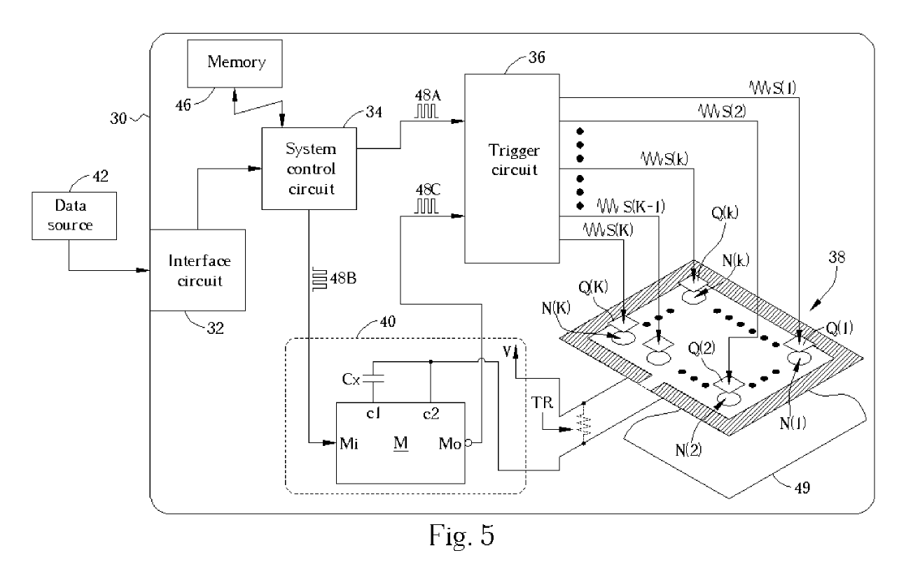

Please refer to FIG. 5, which illustrates a block diagram of an implementation of a present invention printer 30. The printer 30 includes an interface circuit 32, a system control circuit 34, a drive circuit 36, a print head 38, a pulse duration control circuit 40, and a memory 46. The interface circuit 32 can receive print data from an electronic print document provided by a data source 42 (such as a PC, or a card reading machine for reading data from a memory card). The system control circuit 34 controls operations of the printer 30, and the memory 46 registers data for operations of the system control circuit 34. Furthermore, the print head 38 includes a plurality of heating units Q(1) to Q(K), and corresponding nozzles N(1) to N(K). The heating units Q(1) to Q(K) can receive corresponding drive signals S(1) to S(K) through the drive circuit 36. When the printer 30 is operating, the interface circuit 32 transmits the waiting print data to the system control circuit 34, and then registers the data in the memory 46. When the printer 30 starts to jet ink, the system control circuit 34 triggers a print trigger signal 48B, and transmits a waiting print data 48A stored in the memory 46 to the drive circuit 36. The drive circuit 36 determines which nozzles need to jet ink according to the print data 48A, and maintains the drive signals at the drive level, which is equal to the pulse wave width of the print enable signal 48C. During the maintenance duration of the drive signals, the corresponding heating units heat ink continuously for jetting ink to a print document 49, thereby completing ink-jet printing.

As mentioned above, the pulse wave width of the print enable signal 48C controls the heating energy amount of each heating unit. In order to compensate for heat accumulation, the print head 38 includes a negative thermal coefficient thermistor TR for temperature detection, so that the pulse duration control circuit 40 can adjust the pulse wave width of the print enable signal 48C according to resistance of the thermistor TR. In FIG. 5, the present invention achieves functions of the pulse duration control circuit 40 with the monostable multivibrator M in FIG. 3. As FIG. 5 illustrates, the input end Mi of the monostable multivibrator M receives the print trigger signal 48B provided by the system control circuit 34 as an input signal, and two connection ends c1 and c2 connected to a capacitor Cx with constant capacitance and the thermistor TR. Please notice that the configuration composed of the connection ends c1, c2, the capacitor Cx, and the thermistor TR in FIG. 5 makes the thermistor TR equivalent to the resistor Rx in FIG. 3. In other words, when the print trigger signal 48B triggers, the monostable multivibrator M in FIG. 5 adjusts the pulse wave width in the output end Mo according to the product of the capacitance of the capacitor Cx and the resistance of the thermistor TR. The output signal of the monostable multivibrator M can be taken as the print enable signal 48C, and can make the drive circuit 36 capable of controlling heating energy accumulation of heating units Q(1) to Q(K) in accordance with the pulse wave width of the output signal. While the temperature of the print head 38 rises, the resistance of the thermistor TR decreases (because of its negative thermal coefficient). Therefore, both the monostable multivibrator M outputs a shorter print enable signal 48C, and the drive circuit 36 curtails heating duration, which prevent negatives effect of heat accumulation.

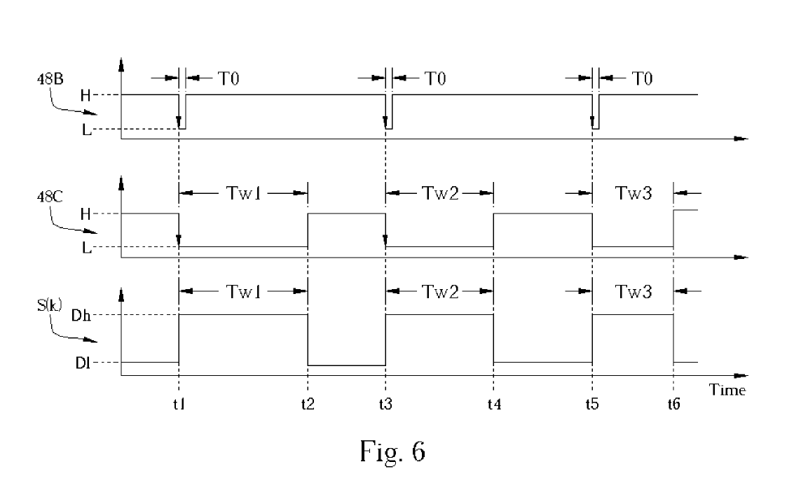

In the present invention, seeing that the pulse duration control circuit 40 can adjust the pulse wave width of the print enable signal 48C, the system control circuit 34 does not occupy system resources for calculating and adjusting the pulse wave width, but triggers the pulse duration control circuit 40 with a stable pulse wave width provided by the print trigger signal 48B. As to this condition, please refer to FIG. 6 (and FIG. 5), which illustrates a related signal waveform diagram in the time domain when the printer 30 in FIG. 5 operates. The X-axis is time scale, and the Y-axis is waveform amplitude. If the printer 30 starts to jet ink at time point t1, the system control circuit 34 can transfer the print trigger signal 48B from the level H to the level L at time point t1, so as to trigger the monostable multivibrator M at the falling edge to transfer the print enable signal 48C from the level H to the level L (or enable level). Therefore, the pulse wave width Tw1 of the print enable signal 48C in the enable level L is proportional to the product of the capacitance of the capacitor Cx and the resistance of the thermistor TR. According to the print data 48A, if some nozzle N(k) is required to jet ink, the drive circuit 36 transfers the corresponding drive signal S(k) from the level Dl to the drive level Dh with the print enable signal 48C at time point t1, and then maintains the drive signal S(k) in the drive level for a duration of the pulse wave width of the print enable signal 48C. Therefore, the heating unit Q(k) heats ink during the duration, so as to jet ink from the nozzle N(k).

At time point t3, if the printer 30 continues to print un-printed data (and make the nozzle N(k) jet ink), the system control circuit 34 will trigger the pulse duration control circuit 40 again at time point t3 at the falling edge, hence the monostable multivibrator M will generate the enable pulse wave at time point t3 according to the temperature of the thermistor TR. Moreover, if the temperature of the print head 38 has risen because of the heat accumulation, resistance of the thermistor at time point t3 is decreased, so that the monostable multivibrator M reduces the pulse wave width Tw2 at time point t3. Therefore, the drive circuit makes the pulse wave width of the drive signal S(k) in the drive level Dh decreased, so as to prevent the heating unit Q(k) from outputting too much heating energy lest print quality is degraded.

Similarly, if the printer 30 starts to print again (and make the nozzle N(k) jet ink) at time point t5, the monostable multivibrator M will determine the pulse wave width of the print enable signal 48C according to the resistance of the thermistor (and the capacitance of the capacitor Cx). Besides, if the temperature of the print head 38 is still high (higher than that between time points t1 and t4), the resistance of the thermistor TR will be decreased much more (smaller than that between time points t1 and t4), with the result that the monostable multivibrator M will make the pulse wave width Tw3 of the print enable signal 48C smaller than the pulse wave widths Tw1 and Tw2. Therefore, the drive circuit 36 will trigger the heating unit Q(k) with a much shorter drive level pulse wave in the drive signal S(k) to compensate the heat accumulation effect.

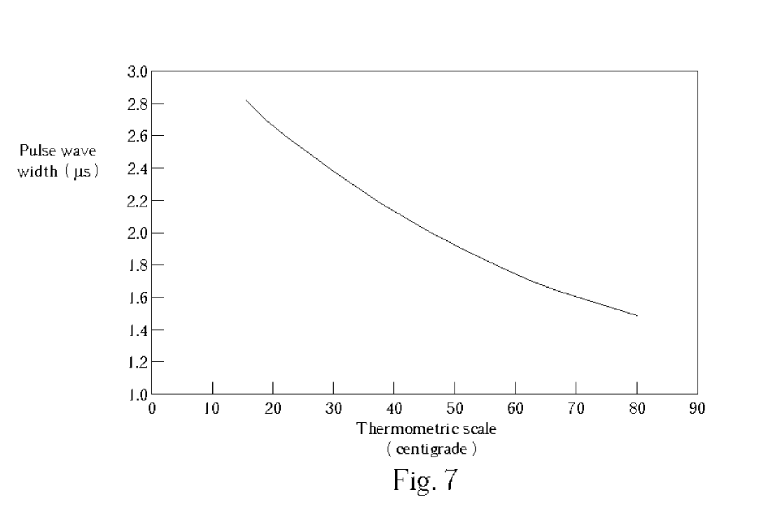

As mentioned above, the monostable multivibrator M of the present invention realizes functions of the pulse duration control circuit 40, and changes the pulse wave width of the print enable signal 48C according to different resistance of the thermistor, so as to compensate for heat accumulation. That is, the printer of the present invention does not need the same measure circuits and A/D converters as the prior art printer 10 does, so that calculation and memory resources needed for the present invention are reduced. To further illustrate pulse wave width adjustment of the pulse duration control circuit 40, please refer to FIG. 7 (also FIG. 5 and FIG. 6), which illustrates a functional relationship diagram of the pulse wave width of the print enable signal 48C in the pulse duration control circuit 40. The X-axis in FIG. 7 is temperature of the print head 38 (the unit is centigrade), and the Y-axis is pulse wave widths of the print enable signal 48C when in the drive level (the unit is μs, microsecond). As FIG. 7 illustrates, as temperature of the print head 38 jumps from 20 degrees to 80 degrees, the pulse wave width of the pulse duration control circuit 40 drops from 2.7 μs to about 1.6 μs. An ideal functional relationship between temperature and pulse wave widths can be provided by adjusting the capacitance of the capacitor Cx and material characters of the thermistor for compensating for heat accumulation.

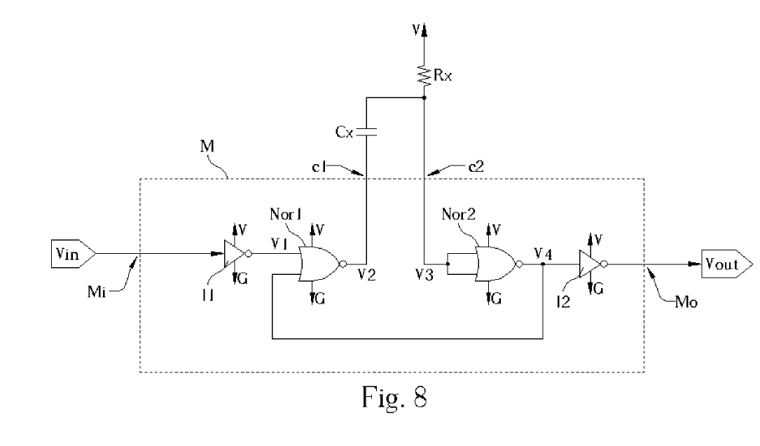

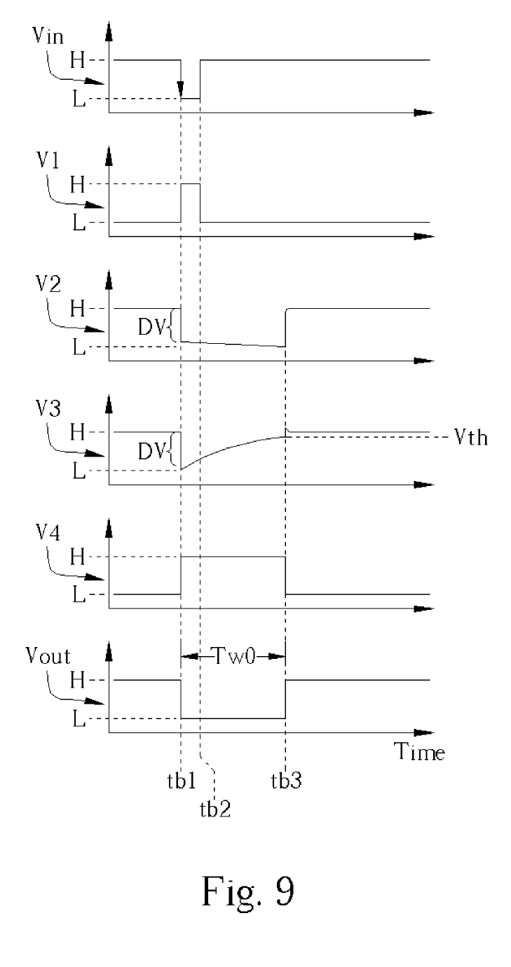

There are many ways to implement the monostable multivibrator M, and the following illustrates one implementation for example. Please refer to FIG. 8 and FIG. 9 (also FIG. 3 and FIG. 4). FIG. 8 is an implementation circuit diagram of the monostable multivibrator M in FIG. 3, while FIG. 9 illustrates a related signal waveform diagram in the time domain when the monostable multivibrator M in FIG. 8 is operating. The X-axis in FIG. 9 is time scale, and the Y-axis is waveform amplitude. In FIG. 8, the monostable multivibrator M can achieve its functions with two inverters I1 and I2, two inverse OR gates Nor1 and Nor2, a resistor Rx, and a capacitor Cx though two connection ends c1 and c2. The inverters I1, I2 and the inverse OR gates Nor1, Nor2 are biased between direct voltage V and G (such as ground voltage). The inverter I1 receives an input signal Vin in the input end Mi and generates a signal voltage V1. After performing an inverse OR on the voltage V1 and V4, the inverse OR gate Nor1 generates the voltage V2 in the connection end c1. Through the capacitor Cx and the resistor Rx connected to the connection end c1 and c2, the voltage V3 is input to two input ends of the inverse OR gate Nor2, which generates the signal voltage V4. Finally, the output signal Vout is generated in the output end Mo through the inverter I2.

As FIG. 9 illustrates, before time point tb1, the input signal stays at the level H (this can be the level of the bias voltage V), while the voltage V1 stays at the level L through the inverter I1 (this can be the level of the bias voltage G). In a stable situation, the capacitor Cx should have no current flow, hence the voltage V3 nears the bias voltage V or the level H, consequently the voltage V4 provided by the inverse OR gate Nor2 is at the level L. Furthermore, the voltage V4 feedbacks to the inverse OR gate Nor1, which is combined with the voltage V1 in the inverse OR gate Nor1 for the output voltage V2 at the level H. Besides, the voltage V4 makes the output signal Vout in the level H after the inverter I2.

Suppose that, at time point tb1, the input signal Vin, which changes from the level H to the level L, triggers the monostable multivibrator M, while the voltage V1 changes from the level L to the level H. After the inverse OR gate Nor1 finishes the inverse OR operation of the voltage V1, the voltage V2 drops a difference voltage DV from the level H to near the level L, so that the voltage across the capacitor Cx decreases the difference voltage DV at the same time because the capacitor Cx cannot change its charge amount rapidly. As a result, the voltage V3 drops to near the level L, and the voltage V4 jumps to the level H. Finally, the output signal Vout changes from the level H to the level L.

Although the capacitor Cx cannot discharge and charge rapidly for the voltage V3 to descend along with the voltage V2, the bias voltage V charges the capacitor Cx through the resistor Rx after time point tb1, so that the voltage V3 increases continuously. At time point tb3, the voltage V3 is charged to a threshold voltage Vth, which is near the level H and can be seen as a digital “1” (the level L is a digital “0”). In other words, at time point tb3, the inverse OR gate Nor2 transfers its output voltage V4 to the level L because the voltage V3 becomes a digital “1”. Therefore, the monostable multivibrator M returns the output signal Vout to the level H, and generates the level L pulse wave with the pulse wave width Tw0 between time point tb1 and tb3. Please notice that the voltage V4 stays at the level H after time point tb1 (until time point tb3), so that even if the input signal Vin returns to the level H at time point tb2, the voltages V2 and V3 are disturbed (as are the voltages V4 and Vout).

As discussed above, the pulse wave width Tw0 of the output signal Vout is determined by the duration of the voltage V3 charging to the threshold voltage Vth. The shorter the duration, the shorter the pulse wave width Tw0. Because the voltage V3 is accumulated by charging the capacitor Cx from the resistor Rx, the charging duration of the voltage V3 is determined by the product of the capacitance of the capacitor Cx and the resistance of the resistor Rx (which is a time constant of a capacitor-resistor circuit). In normal situations, the charging duration of the voltage V3 is directly proportional to the time constant, the product of the capacitance of the capacitor Cx and the resistance of the resistor Rx. Therefore, the present invention establishes the thermistor of the print head as the resistor Rx.

In FIG. 8 and FIG. 9, the monostable multivibrator (and the pulse duration control circuit) of the present invention is a simple, efficient, low-cost circuit. Therefore, cost of the present invention can be decreased efficiently, and so can system resources for compensating for heat accumulation. Certainly, alternative solutions regarding the monostable multivibrator M exist. For example, in some circuit configurations, a pulse wave width of the output signal can be determined by a discharge duration of the capacitor Cx through the resistor Rx. Accordingly, the monostable multivibrator of the present invention can achieve the heat accumulation compensation via discharging and charging the capacitor Cx through the resistor Rx under the input signal triggering, and then triggering changes of the output signal based on discharging and charging duration of the capacitor.

In summary, although the prior art printer can measure a print head's temperature through a thermistor, it needs both a high-cost A/D converter to convert resistance of the thermistor to digital and high system resources for calculation and adjustment. This makes the prior art printer high cost, but low in efficiency. In contrast the present invention can achieve functions of a pulse duration control circuit with a simple/low-cost monostable multivibrator, which can not only reduce cost and system resources effectively, but also compensate for heat accumulation and promote printer efficiency.

Those skilled in the art will readily observe that numerous modifications and alterations of the device may be made while retaining the teachings of the invention. Accordingly, the above disclosure should be construed as limited only by the metes and bounds of the appended claims.

1. A printer comprising:
a print head comprising at least one nozzle, each nozzle for heating ink for jetting ink to a print document;
a thermistor disposed in the print head, wherein resistance of the thermistor changes as temperature of the print head changes;
a pulse duration control circuit providing a current for a capacitor through the thermistor, generating a print enable signal based on a discharging and charging duration for the current flowing to the capacitor, enabling an enable maintenance duration of the print enable signal corresponding to the discharging and charging duration for the current flowing to the capacitor; and
a drive circuit, connected between the pulse duration control circuit and the print head, generating at least one ink-jet drive signal based on the print enable signal, enabling energy of each ink-jet drive signal corresponding to the enable maintenance duration of the print enable signal; each jet ink drive signal corresponding to a nozzle for heating ink with the corresponding nozzle according to the corresponding energy of the jet ink drive signal.

2. The printer of claim 1 further comprising:
a system control circuit generating a print trigger signal when the printer is jetting ink on the print document, the pulse duration control circuit changing the print enable signal to an enable level after the print trigger signal is triggered, enabling the enable maintenance duration of the print enable signal corresponding to the discharging and charging duration for the current flowing to the capacitor.

3. The printer of claim 2, wherein the system control circuit controls the drive circuit according to a print data for providing the ink-jet drive signal for the nozzle for jetting ink.

4. The printer of claim 1, wherein resistance of the thermistor degrades as temperature of the print head rises, the pulse duration control circuit reducing the enable maintenance duration of the print enable signal as the resistance of the thermistor decreases.

5. The printer of claim 4, wherein the shorter the enable maintenance duration of the print enable signal, the less the energy of each ink-jet drive signal provided by the drive circuit.

6. The printer of claim 4, wherein the drive circuit enables a drive maintenance duration of the ink-jet drive signal corresponding to the enable maintenance duration of the print enable signal; the printer enabling the energy of the ink-jet drive signal corresponding to the enable maintenance duration of the print enable signal.

7. The printer of claim 1, wherein the shorter the enable maintenance duration of the print enable signal, the less the energy of each ink-jet drive signal provided by the drive circuit.

8. The printer of claim 1, wherein the drive circuit enables a drive maintenance duration of the ink-jet drive signal corresponding to the enable maintenance duration of the print enable signal; the printer enabling the energy of the ink-jet drive signal corresponding to the enable maintenance duration of the print enable signal.

9. The printer of claim 1, wherein the pulse duration control circuit comprises a monostable multivibrator.

10. A method for a printer to adjust energy of each nozzle in the print head for heating ink according to the print head's temperature, the method comprising:
providing a thermistor in the print head, the resistance of the thermistor changing as temperature of the print headchanges;
processing a wave control step for providing a current for a capacitor through the thermistor, generating a print enable signal based on a discharging and charging duration for the current flowing to the capacitor, enabling an enable maintenance duration of the print enable signal corresponding to the discharging and charging duration for the current flowing to the capacitor; and
processing a drive step for generating at least one ink-jet drive signal according to the print enable signal, enabling the energy of each ink-jet drive signal corresponding to the enable maintenance duration of the print enable signal; each ink-jet drive signal corresponding to a nozzle for heating ink by the corresponding nozzle based on the corresponding energy of the jet ink drive signal.

11. The method of claim 10 further comprising:
processing the wave control step when the printer prints a print document by jetting ink for transforming the print enable signal into an enable level, enabling the enable maintenance duration of the print enable signal corresponding to the discharging and charging duration for the current flowing to the capacitor.

12. The method of claim 10 further comprising:
selecting nozzles for jetting ink based on a print data when processing the drive step, providing the ink-jet drive signals for the nozzles.

13. The method of claim 10, wherein the resistance of the thermistor decreases as temperature of the print headrises; when processing the wave control step, decreasing the enable maintenance duration of the print enable signal as the resistance of the thermistor decreases.

14. The method of claim 13, wherein when processing the drive step, the shorter the enable maintenance duration of the print enable signal, the less the energy of each ink-jet drive signal.

15. The method of claim 13, wherein when processing the drive step, enabling the drive maintenance duration of the ink-jet drive signal corresponding to the enable maintenance duration of the print enable signal, enabling the energy of the ink-jet drive signal corresponding to the enable maintenance duration of the print enable signal.

16. The method of claim 10, wherein when processing the drive step, the shorter the enable maintenance duration of the print enable signal, the less the energy of each ink-jet drive signal.

17. The method of claim 10, wherein when processing the drive step, enabling the drive maintenance duration of the ink-jet drive signal corresponding to the enable maintenance duration of the print enable signal, enabling the energy of the ink-jet drive signal corresponding to the enable maintenance duration of the print enable signal.

18. The method of claim 10, wherein when processing the wave control step, adjusting the enable maintenance duration of the print enable signal by a monostable multivibrator.
